(19) United States
(12) Patent Application Publication
(10) Pub. No.: US 2011/0131714 A1
(43) Pub. Date: Jun. 9, 2011

(54) CONSUMABLE PRODUCT DISPENSING SYSTEM AND METHOD

(76) Inventors: Roelof Remijn, Ph's-Gravendeel (NL); Sheldon Schwartz, Lexington, MA (US)

(21) Appl. No.: 12/634,034

(22) Filed: Dec. 9, 2009

(51) Int. Cl. A47K 13/00; B67D 7/08

(52) U.S. Cl. 4/233; 222/52

(57) ABSTRACT

A consumable material includes a specific concentration of a chemical additive. The consumable material is held in a dispensing system includes a sensor that detects the concentration of the chemical additive within the consumable material. A controller compares the detected concentration of the chemical additive and if the proper concentration is not detected, the system prevents the dispenser from releasing the consumable material.

### BACKGROUND

Dispensing systems provide consumable products to people. These consumable products include cleaning solutions, liquid soap, paper towels, toilet paper, beverages, toothpaste, deodorants, fragrances, etc. A consumer or a business will typically purchase a dispensing system which is filled with the consumable products. When the products are depleted, the user will have to refill the dispenser with the consumable product. In some cases, the seller of the dispensing system will want the dispensing system refilled with the seller's consumable products. A potential problem with dispensing systems is that they can be refilled with consumable products from another supplier.

What is needed is a is system which can detect certain properties of the consumable product to determine if the consumable product was manufactured or authorized by the seller of the dispensing system or if the consumable product was purchased by another supplier.

### SUMMARY OF THE INVENTION

The present invention is directed towards a system that dispenses a consumable product such as a liquid or paper. The system includes a sensor that detects a chemical additive in the liquid or paper or a physical property of the liquid or paper. The system also stores an expect value for the sensor measurements. The type of sensor will depend upon the type of consumable product being used. If the consumable product is a liquid and the additive is a chemical, the sensor must detect the presence of the proper concentration of the chemical additive. If this condition is met, the dispenser system will function properly. If the chemical additive is not detected or detected outside the required concentration range, the system will prevent the consumable product from being removed from the dispenser. Similarly, if the physical property is detected the system will operate as designed and the consumable product will be supplied by the dispensing system.

In another embodiment, the system can be used to dispense other types of consumable products such as disposable paper products such as paper towels, paper toilet seat covers, etc. The system can include sensors that detect the presence of a chemical that is in the disposable paper products or a physical property of the paper products. If the chemical is detected the dispensing system will function properly and if the chemical is not detected, the system will not allow the paper products to be removed from the dispenser.

Various types of sensors can be used with the inventive system. An electrode sensor can be used to detect the electrical resistance of a fluid. An optical sensor can detect the spectral absorption or refraction of the fluid to detect a specific chemical additive or refractive property of the fluid.

### BRIEF DESCRIPTION OF THE DRAWINGS

FIG. 1 illustrates a circuit used to detect the resistivity of a consumable fluid;

FIG. 2 illustrates an optical sensor used to detect the spectral absorption of a consumable fluid;

FIG. 3 illustrates an optical sensor used to detect the refractive properties of a consumable fluid;

FIG. 4 illustrates a side view of a self cleaning toilet;

FIG. 5 illustrates a front view of a self cleaning toilet;

FIG. 6 illustrates a view of the internal components of a self cleaning toilet;

FIG. 7 illustrates a view of the internal components of a paper towel dispenser; and

FIG. 8 illustrates a view of a paper towel dispenser with a chemical additive applied to one side of a paper towel.

### DETAILED DESCRIPTION

The present invention is directed towards a consumable product dispensing system that detects specific properties of the consumable product to determine if one or more specific materials are present in a specific concentration within the consumable product. In an embodiment, the consumable product is a liquid stored in a container. The liquid can be any type of consumable such as cleaning fluids, beverages, syrups, gels, sun screen, shampoo, liquid soap, water, oil, gasoline, ethanol, etc. A sensor is in contact with the fluid stored in the container. The sensor detects a physical or chemical characteristic of the fluid and transmits a signal to a controller. The controller compares the sensor signal to an expected signal value range and determines if the specific materials are present in the consumable fluid. If the sensor signal is within the acceptable range, the controller will allow the dispenser to function. If the sensor signal is outside the acceptable range, the controller will cause the dispenser to cease operating.

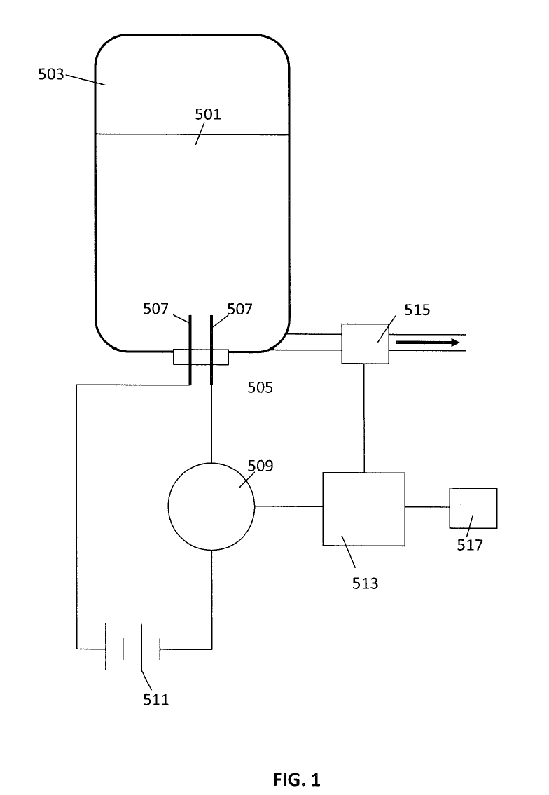

In an embodiment, the fluid includes a specific concentration of an electrolyte additive. With reference to FIG. 1, the sensor 505 is in contact with a container 503 that holds a fluid 501 includes two electrodes 507 that are positioned in parallel. An electrical voltage 511 is applied to the electrodes 507 and the resistivity of the fluid 501 is measured. A normal fluid solution will have a high electrical resistivity. However, when a salt, like sodium chloride is dissolved in water the sodium and chloride separate temporarily. The sodium atom will become a positively charged ion and the chloride atom will become a negatively charged ion. The salts, such as sodium chloride, behave as electrolytes when dissolved in water.

The electrolytes cause the fluid 501 to be more conductive. Thus, when a voltage is applied to the sensor electrodes 507, the detected conductivity is higher than a fluid 501 that does not contain salt. The conductivity of the fluid 501 is proportional to the concentration of the salt. A higher concentration will increase the electrical conductivity. The relationship between the voltage and conductivity is (σ) Conductivity=1/(ρ) Resistivity. Conductivity can be measured in units of Siemens per meter. As examples of conductivity Table 1 below indicates the conductivity for different concentrations of salt electrolytes in water.

TABLE 1

| | Electrical |
|---|---|
| Type of Water | Conductivity (S/m) |
| Sea Water-35 grams of salt/kilogram | 4.8 |
| Drinking Water | 0.0005 to 0.05 |
| Deionized Water with dissolved CO₂ | 7.5 × 10⁻⁵ |
| Deionized Water | 5.5 × 10⁻⁶ |

The sensor can include two electrodes 507 with a fixed voltage applied across the leads. The electrodes are made from electrically conductive materials such as non-corrosive metals. The surface area of the electrodes can be about 0.1 to 3 cm² and the distance between the electrodes can be between about 0.5 to 5 cm. The conductivity of the cleaning fluid can be determined by measuring the current flowing between the electrodes with an ammeter 509. In an embodiment, the concentration of electrolytes or salts in the fluid can be from less than about 1% to about 2%.

In an embodiment, the sensor can be configured to detect the electrical conductivity of the liquid and can be set to detect any range of values between about 0.0001-10 Siemens per meter (S/m). The system can be configured to only dispense fluids having a specific range of electrical conductivities. For example, the system can be used with fluids that have a target range of 0.00001 to 1,000 s/m. However, in a more preferred embodiment, the detected conductivity can range from about 0.001 to 0.2 S/m. The output of the ammeter 509 can be coupled to the controller 513 and the controller 513 can be coupled to a flow controller 515 which can be a valve or a pump. If the detected conductivity of the fluid is within the target range, the controller 513 will allow the cleaning fluid to flow through the flow controller 515 and the system operates properly. In contrast, if the conductivity of the fluid is outside the target range, the controller 513 will cause the system to stop operating.

The controller can also be coupled to another switch 517 which detects a command from a user. The switch 517 can be a manually operated switch or an optical sensor that detects a hand or body in the proximity of the switch 517. Under normally operating conditions, when the switch 517 is actuated the flow controller 515 will allow the fluid 501 will flow out of the storage container 503. In contrast, if the system stops operation due to an electrical resistance outside the predetermined range, the controller 513 will prevent the fluid 501 from flowing through the flow controller 515.

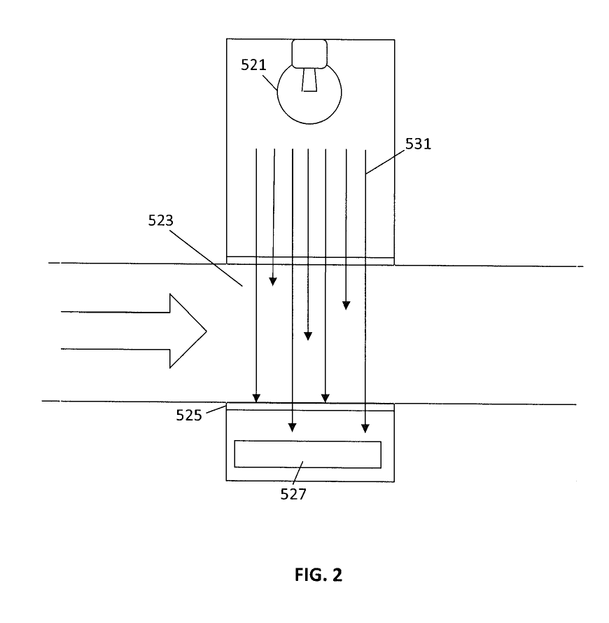

In other embodiments, different types of sensors can be used to detect a material in the consumable product or a physical property of the consumable product. For example, an optical chemical sensor can be used to analyze the contents of the cleaning fluid. With reference to FIG. 2, the main components are a light source 521, a sample chamber 523, a wavelength filter 525, and the light detector 527. A sample of the fluid enters the sample chamber 523, and the concentration of specific molecules is measured electro-optically by its absorption of a specific wavelength of light. The light rays 531 are directed through the sample chamber 523 towards the detector 527. The detector 527 can have an optical filter 525 that eliminates all light except the wavelength that the selected chemical additive molecules absorb.

Absorption spectroscopy is used to detect the chemical additive molecules present in a sample, which can be a solid, liquid, or gas, and subsequent promotion of electron(s) from one energy level to another in that substance. The wavelength at which the incident photon is absorbed is determined by the difference in the available energy levels of the different substances present in the sample. Various wavelengths of light can be used to detect the chemical composition. In absorption spectroscopy the absorbed photons are not re-emitted and the absorbed energy is transferred to the chemical compound upon absorbance of a photon.

At a given wavelength, the measured absorbance has been shown to be proportional to the molar concentration of the absorbing chemical species. The amount of radiation absorbed versus wavelength for a particular compound is referred to as the absorption spectrum. At wavelengths corresponding to the resonant energy levels of the sample, some of the incident photons are absorbed, resulting in a drop in the measured transmission intensity and a corresponding drop in the transmitted optical spectrum. The absorption spectrum can be measured using a spectrometer and by knowing the shape of the spectrum, the optical path length and the amount of radiation absorbed, the chemical components and the concentrations of the compounds can be determined. The optical system can be equipped with spectral filters to eliminate optical wavelengths that are outside the range of interest.

While the absorption spectroscopy has been described for detecting chemicals in a liquid, absorption spectroscopy can also be used to detect specific chemicals in solid objects. In this embodiment, a solid object such as a piece of paper can be placed between the light source and the optical sensor detector. Specific chemicals in the paper which can be chemical additives applied to the paper will absorb specific wavelengths of light. Some light will be transmitted through the paper, however some specific wavelengths of light will be absorbed by chemicals in the paper. Since these wavelengths are absorbed by the paper, the sensor will not detect these absorbed wavelengths. Because the chemical additive may not be spread over the entire paper, the sensor may have a reduced quantity of light at the absorbed wavelengths rather than complete blockage of this wavelength. If the chemical additive is detected in the required range, the system will function properly. If the required concentration of the chemical additive is not detected, the system can cause the controller to stop the consumable product from being removed from the dispenser.

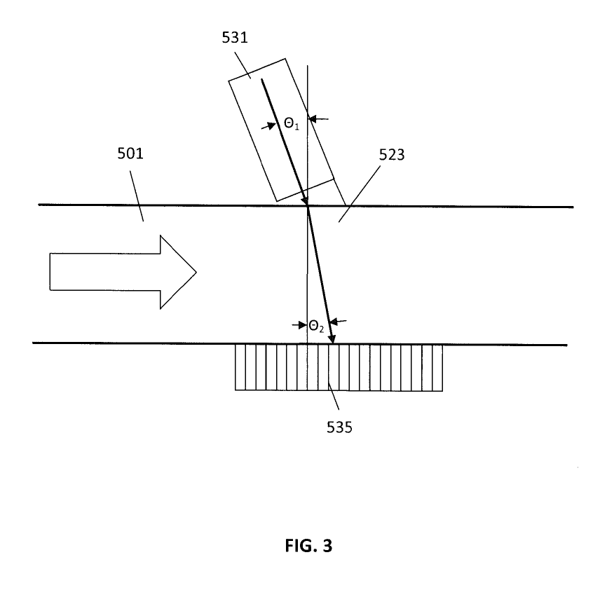

In another embodiment, the presence of a chemical additive can be detected by a sensor that measures the refraction of light through the liquid. With reference to FIG. 3, a refractive detection system is illustrated that includes a light source 531, a fluid chamber 532 and an array of light sensors 535. A piece of glass can separate the light source 531 from the liquid 501. The light beam contacts the intersection of the glass and fluid at a first fixed angle, θ1 and the light beam is refracted at the intersection causing the light beam to bend to a second angle, θ₂. The array of sensors 535 is arranged on the opposite side of the fluid chamber 523 to detect the angle of refraction, θ₂. Light refraction is described by Snell's law, which states that the angle of incidence is related to the angle of refraction by sin θ₁/sin θ₂=ν_{1/}ν₁=n₁/n₂ or n₁ sin θ₁=n₂ sin θ₂. The variables in these equations are defined as follows: ν₁ and ν₂ are the wave velocities through the respective media, θ₁ and θ₂ are the angles between the normal (to the interface) plane and the incident waves respectively and n₁ and n₂ are the refractive indices.

A fluid 501 containing a chemical additive can have a specific index of refraction while a fluid 501 that does not have the required combination of chemicals can have a different index of refraction. In this embodiment, the system will detect the proper chemical combination based upon the detected index of refraction. If the angle of refraction is not within the required range, the system will cause the flow controller to prevent fluid 501 from flowing from the storage container. Because the angle of the refracted light must be precisely detected, a laser light source may be used.

In addition to chemical detection, the system can also monitor the pH-value of the cleaning solution. In an embodiment, the pH sensor may comprise a pH electrode consisting of a pH sensitive membrane sealed to an insulating tube containing a solution of fixed pH in contact with a silver-silver chloride half cell. The potential developed across the membrane is compared to a stable reference potential. The circuit is completed by means of a porous constriction which allows the reference electrolyte to slowly flow into the sample. The gel electrode is a sealed reference. The pH provides an indication of whether a batch solution is acidic or basic and is defined as pH=−log(H+) and covers a scale from 0 (acid) to 14 (alkaline) where H+ is the hydrogen concentration in solution, at normal room temperatures. The system can compare the detected pH value for the batch to a target pH value. In an embodiment, the cleaning solution may be slightly acidic and have a target pH value of 4-5. If the pH value is significantly different than the target value, the controller can stop the system from operating.

In an embodiment, the system may detect the level of oxygen in the cleaning solution. An exemplary technique for measuring dissolved oxygen includes a dissolved oxygen sensor that includes an anode and cathode which are immersed in electrolyte within the sensor body. An oxygen permeable membrane separates the anode and cathode from the batch liquid being measured and oxygen diffuses across the membrane. The cathode is a hydrogen electrode and carries a negative potential with respect to the anode. Electrolyte surrounds the electrode pair and is contained by the membrane. With no oxygen passes through the membrane, the cathode becomes polarized with hydrogen and resists the flow of current. When oxygen passes through the membrane, the cathode is depolarized and electrons are consumed. The cathode electrochemically reduces the oxygen to hydroxyl ions and the anode reacts with the product of the depolarization with a corresponding release of electrons. The oxygen interacts with the internal components of the probe to produce an electrical current. The output from the dissolved oxygen sensor can be a variable electrical voltage in millivolts. The electrode pair permits current to flow in direct proportion to the amount of oxygen entering the system. The magnitude of the current is a direct measure of the amount of oxygen entering the probe. In an embodiment, the system can detect the quantity of dissolved oxygen in the fluid. In an embodiment, a dissolved oxygen level of between about 10% and 20% is acceptable but oxygen levels outside this range will cause the system to stop.

The inventive sensor system can be used to insure that the proper fluids are being used with the dispenser. This can be done to insure that the proper fluids are being used with the dispensing system. It can also be used to prevent consumable materials that are not produced by the manufacturer from being used in the dispensing system. The dispensing system may be sold with the intent that the consumable product used to refill the dispenser must purchase the from the device manufacturer. Thus, the manufacturer may profit more from the sale of the consumable products than the device itself. The sensor system can be configured to detect specific chemical(s) that are present in the fluids produced by the manufacturer and used in the dispenser.

In an embodiment, the cleaning fluid contains one or more of the following components: ethanol, propan, 1-putanol and didecldimethylammonium chloride. The possible concentrations of each of these components are listed in Table 2 below. As discussed, the additive component can be added to the fluid for detection by the sensor.

TABLE 2

| Component | Percentage Range |
|---|---|
| Water | 1-95% |
| Ethanol | 0.01-70% |
| Propan-2-ol | 0.01-50% |
| 1-Butanol | 0.01-50% |
| Didecyldimethylammonium | 0.01-50% |
| Chloride | |

While the system has been described as being used to detect a specific chemical in a dispensed liquid, it can also be used to detect chemicals in other consumable products. For example, paper products such as paper towels and toilet paper are commonly stored in dispensers. In an embodiment, the system can detect chemicals or physical properties of the paper products. For example, the paper products can be moved between a light source and an optical sensor. The paper will block many wavelengths but some light may be transmitted through the paper. As discussed, certain materials absorb specific wavelengths of light. Thus, if the light source emits a wavelength of light that is absorbed by the paper containing the material, the sensor will not detect the wavelength.

The system is compatible with various types of dispensing devices may be used to process solid, liquid and gaseous substances. For example, some devices such as air fresheners heat a solid air freshener substance that emits fragrance. Fluid dispensers include soap, hand lotion, shampoo, self cleaning toilet dispensers, air fresheners, etc. The inventive system can also be used in more industrial or commercial applications including: gasoline, ethanol, beverages, etc. The inventive system can also be used with paper dispensers including toilet paper, paper towel, toilet seat protectors, paper napkins, moisture containing materials such as disposable wet wipes, etc. Some air fresheners and perfumes are stored in a liquid state and then mixed with a gas and emitted as a fine spray through a nozzle. In some cases, an atomizer nozzle can be used to emit a fine spray of many liquid droplets. As discussed, if the sensor does not detect the proper concentration of a specific chemical or a specific chemical characteristic, the system can cause the dispenser to shut down and a status indicator can be actuated. The system may remain in this condition until the proper consumable product is inserted into the dispenser.

In the shut down condition, the dispenser may not allow the consumable product to be removed from the dispenser. An example of a special cleaning solution dispenser is a self cleaning toilet seat which may apply a cleaning solution over the seat before and/or after each use. A compatible self cleaning toilet seat is disclosed in PCT/US04/25199, “Self Cleaning Toilet Seat” which is hereby incorporated by reference. The self cleaning toilet seat requires cleaning fluids and an electrical power supply. These advanced toilets may have cleaning fluid storage tanks and power supplies within a housing that is part of the toilet. The electrical power supply may be used to drive the mechanisms used to clean the toilet or pumps used to control the flow of the cleaning fluid.

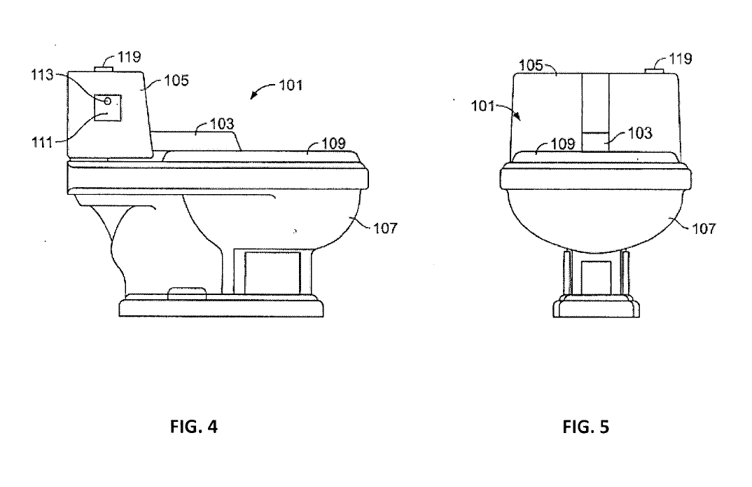

With reference to FIGS. 4 and 5, a toilet 101 having a self-cleaning toilet seat mechanism 103 is illustrated. The seat cleaning mechanism 103 is normally stored in a housing 105 attached to the bowl 107 of the toilet. Before using the toilet 101, the person has the option of cleaning the seat. A switch is actuated and the cleaning mechanism 103 is removed from the housing 105 and is placed over a portion of the toilet seat 109. The cleaning mechanism 103 sprays a cleaning fluid on the seat 109 and wipes the seat clean as the seat 109 rotates. After the entire seat 109 is sprayed and wiped, the mechanism retracts back into the housing 105. This process results in a clean seat 109. The toilet 101 may also have a door 111 and a lock 113 built into the housing 105 which allows access to internal components which may require periodic maintenance such as recharging or replacing power supplies and replenishing cleaning fluids. A special cleaning fluid may be sprayed and electrical power may be required to actuate fluid valves and run the pumps used to spray the cleaning fluid.

Switches are used to control the operation these toilet seat cleaning mechanism. Traditional electrical switches are manually operated and require the user to physically touch the switch. Because the toilet may be in a public environment, this physical contact is not desirable. Various other switches are available which may be more suitable for use in this application. Optical proximity switches and audio switches will perform these same functions without physical contact. The optical switch may be actuated by waving a hand over the top of the housing near the optical sensor 119. If the toilet has multiple functions, a separate optical switch 119 may be required for each operation.

In other embodiments, the toilet 101 is capable of multiple functions, audio or voice recognition switching allows multiple mechanisms to be controlled with a single smart switch. The user can simply voice the commands for the desired toilet operations. In this embodiment, a more complex electrical system is required which includes a microphone, a voice recognition unit and an electrical relay switching unit for providing the required electrical power to the motors. The operator can also instruct the toilet to cease operations and reset any mechanical devices.

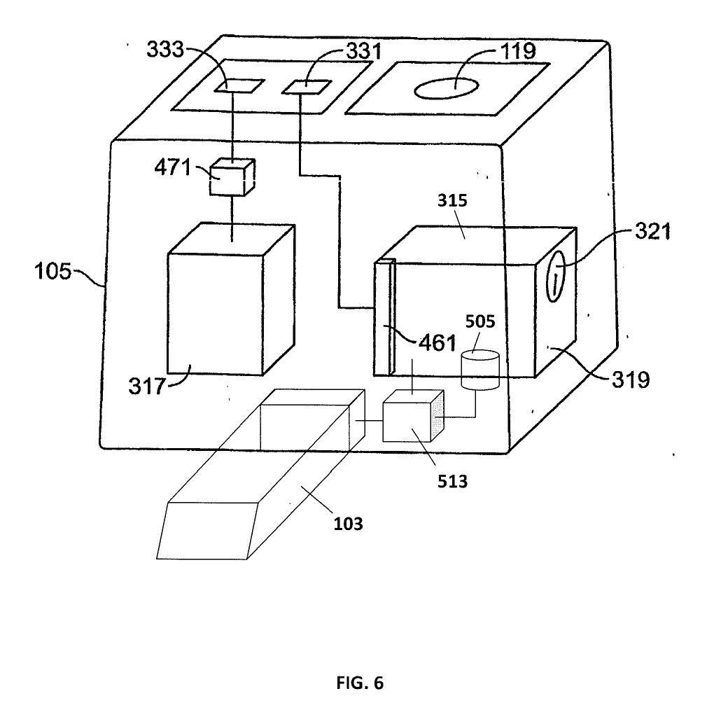

With reference to FIG. 6, the internal components of the self-cleaning toilet seat are illustrated. Indicators 331, 333 can provide information regarding the level of cleaning fluid in the tank 315 and charge left in the electrical power supply 317. The cleaning fluid tank 315 must be refilled periodically as the cleaning fluid is consumed by repeated cleaning processes. In an embodiment, the inventive toilet has a sensor 461 that detects the cleaning fluid level and produces a signal which indicates that the tank 315 needs to be refilled. Various level sensors 461 are compatible with the inventive toilet seat. The fluid level sensor 461 can be a simple float device which floats on top of the cleaning fluid in the tank 315. The float may be attached to a visual gage 331 which provides a visual indication of the fluid level similar to that of a car gas tank. This gage 331 may be mounted in the housing 105 at a location visible to a person standing close to the toilet. The tank float may also be attached to an electrical switch which provides a signal indicating the fluid level. The display may provide the actual fluid level or provide a general indication of cleaning fluid in the tank with indicator light, a green light may indicate full, yellow may indicate low and red may indicate empty. When the cleaning fluid level is low, a switch may deactivate the seat cleaning mechanism. In an embodiment, a portion of the housing 105 or the door 319 may be transparent so that the fluid level of the tank can be seen.

The fluid level may also be detected by various other sensors including: ultrasonic, electrical, mechanical, optical, pressure sensor or any other fluid level sensing device. This electrical signal can be fed to a visual gage 331 or even a transmitter which sends a radio or electrical signal indicating the need for the cleaning fluid tank to be refilled. The fluid level signals for a plurality of toilets can be forwarded to a central location where each of the units can be monitored.

The inventive toilet may also include an electrical power charge detector. If the toilet has a battery type electrical power supply 317, it will be necessary to check the charge level to avoid having the unit run out of electrical power when needed. It is possible to open the power supply door and check the power level, however this is inconvenient and time consuming. A better method for determining the power level is with an internal power meter 471. The power meter 471 transmits a power level signal to a visual display 333. The visual display 333 may be a simple optical device like an LED which glows green to indicate that the power supply 317 is charged and red to indicate that the power supply 317 is dead. Alternatively, the visual display 333 may be an analog gage or a numeric display. Like the cleaning fluid level, the power level visual display 333 is mounted in the housing 105 at a position visible to a person standing near the toilet. A problem with many power meters 471 is that they consume power. In order to avoid this power draw, the power meter 471 may be connected to a switch. When the switch is actuated, the power meter 471 and visual display 333 indicate the power level of the power supply 317. After the power level visual display 333 has been viewed, the switch can be released and the gage disconnected from the power supply 317. Alternatively, the power meter 471 may emit an electrical or radio signal which is forwarded to a central location where the conditions of a plurality of toilets can be monitored.

The seat cleaning fluid may include water, alcohol, liquid soap, disinfectant, trisodium phosphate, baking soda, acetone, or other chemicals which are suitable for cleaning and a chemical additive which can be a salt. In these illustrations, the cleaning fluid tank 315 is a liquid container and the chemical additive sensor can be coupled to the bottom of the tank 315. When the tank 315 is low or empty, the tank 315 can be filled with the cleaning fluid 101 containing the chemical additive. In alternative embodiments, the door 319 may allow access to a filling hole for the tank 315 which allows the cleaning fluid 101 to be poured or pumped into the tank 315. Although the tank 315 is shown as an open top unit, it may also be a closed unit having a closure mechanism. The tank 315 may also be a disposable unit. After the fluids are consumed, the old empty tank 315 may be disconnected from a feed tube in the housing 105 and discarded. A full replacement is then connected to the feed tube. The additive sensor 505 can be removed with the empty tank 315. In this embodiment, the sensor 515 can include an electrical coupling that engages a corresponding coupling to connect the sensor 515 to the electrical system. Alternatively, the sensor 515 can be a fixed part of the seat cleaning mechanism.

If the sensor 505 detects that the proper concentration of the chemical additive or the proper physical properties exist in the cleaning solution, the system will allow the cleaning fluid to be transmitted to the cleaning mechanism 103 so the cleaning of the seat will be performed automatically or on command by a user. However, if the required characteristics are not detected, the system can be shut down. In the shut down condition, the cleaning solution may not be pumped from the tank 315 or delivered to the cleaning mechanism 103 used to clean the seat. Without the fluid flow functionality, the dispensing system will not be useful. The system may output a signal indicating that the cleaning fluid is not from the manufacturer and therefore the system is shut down.

A similar operation will occur in other consumable fluid dispensing systems. If the required additive or chemical properties are not detected, the dispenser will be shut down. Fluids such soaps, lotions or shampoos or other liquids/gels will be trapped in the dispenser in the shut down condition. The system can also be used for paper products in a delivery system. In these embodiments, the system sensor detects a chemical additive or a physical property of the paper. The sensor can be in direct contact with the paper products or be an optical system that detects the wavelengths of light transmitted through or absorbed by the paper. If the chemical additive or physical property is not detected, the system will be shut down. In the shut down condition, the delivery system of the dispenser may be shut off or locked so that paper products cannot be removed.

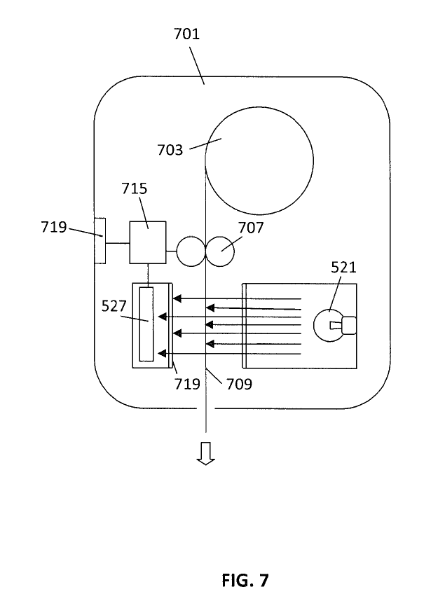

With reference to FIG. 7, a paper towel dispenser 701 is illustrated. The paper towels 709 can be stored on a roll 703 within the dispenser 701. A feed mechanism 707 pulls the paper 709 from the roll 703 and transports the paper 709 through an optical sensor 711. The optical sensor 711 can be an absorption spectroscopy device that includes a light source 521 and an optical detector 527. Specific chemicals in the paper 709 will absorb specific wavelengths of light and the light that is transmitted through the paper 709 will not include the wavelengths of light absorbed by the chemical additive in the paper. A filter 719 can be placed in front of the sensor 527 to block all wavelengths of light other than the wavelengths absorbed by the chemical additives. Thus, the sensor 527 may only detect light when the chemical additive is not in the paper. Alternatively, the chemical additive may reduce, rather than completely block, the quantity of light at the target wavelengths that passes through the paper 709. The sensor 527 is coupled to a controller 715 that can compare the detected optical intensity to an expected value. If the chemical additive is detected within the required range, the controller 715 will allow the feed mechanism 707 to operate and the system will function properly. If the required concentration of the chemical additive is not detected, the controller 715 can cause the feed mechanism 707 to stop the paper towels 709 from being removed from the dispenser 701 when the switch 719 is actuated to feed the paper 709.

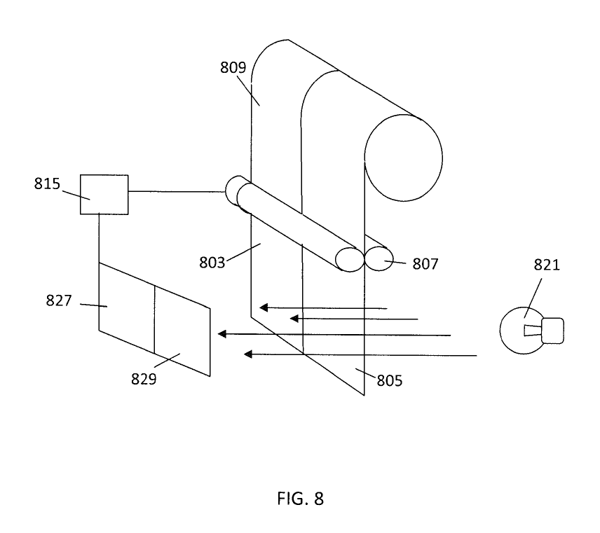

With reference to FIG. 8, in an embodiment, the chemical additive may only be applied to one side of the paper towel 809. When the paper 809 is placed in the optical detector 827, light from the light source 821 will contact the paper towel 809. One side 803 of the paper 809 will block the target wavelength of light while the other side 805 will allow the target wavelength of light to pass. The system can include multiple light detectors 827, 829. The light detector 827 over the chemically treated side 803 will detect a lower transmitted intensity of the blocked wavelength than the light detector 829 over the side 805 that is not chemically treated. The sensors 827, 829 can be coupled to the controller 815 that must detect a difference in detected light. If the difference in transmitted intensity for the target wavelength is not detected, the controller 815 can stop the feed mechanism 807 from operating so that the paper towels 809 cannot be removed from the dispenser 801. In other embodiment, any portion or portions of the paper 809 can include the chemical additive.

It will be understood that the inventive system has been described with reference to particular embodiments, however additions, deletions and changes could be made to these embodiments without departing from the scope of the inventive system. For example, the same processes described can also be applied to other devices. Although the systems that have been described include various components, it is well understood that these components and the described configuration can be modified and rearranged in various other configurations.

What is claimed is:

1. A fluid dispenser comprising:
a fluid container for storing the fluid;
a sensor coupled to the fluid container for detecting a concentration of a chemical additive in the fluid;
a controller coupled to the sensor for comparing the concentration of the chemical additive in the fluid with a predetermined range of values;
wherein if the concentration of the chemical additive in the fluid is not within the predetermined range of values the fluid dispenser will prevent the fluid from being removed from the container.

2. The fluid dispenser of claim 1 further comprising:
a valve coupled to the fluid container;
wherein if the concentration of the chemical in the fluid is not within the predetermined range of values, the controller will close the valve.

3. The fluid dispenser of claim 1 further comprising:
a pump coupled to the fluid container;
wherein if the concentration of the chemical in the fluid is not within the predetermined range of values, the controller will not actuate the pump.

4. The fluid dispenser of claim 1 wherein the chemical additive is a salt and the sensor includes two electrodes that detect the electrical resistivity of the cleaning fluid.

5. The fluid dispenser of claim 1 wherein the sensor includes an optical sensor that detects a light wavelength associated with the chemical additive.

6. The fluid dispenser of claim 1 wherein the sensor includes pH sensor that detects a pH level of the fluid.

7. The fluid dispenser of claim 1 wherein the sensor includes an oxygen sensor that detects a dissolved oxygen level of the fluid.

8. The fluid dispenser of claim 1 wherein the chemical additive is a salt.

9. The fluid dispenser of claim 1 wherein the sensor is coupled to a portion of the fluid container.

10. A self cleaning toilet seat comprising:
a toilet seat;
a fluid container for storing a cleaning fluid;
a sensor coupled to the fluid container for detecting a concentration of a chemical additive in the fluid;
a seat cleaning mechanism coupled to the fluid container for cleaning the toilet seat;
a controller coupled to the sensor for comparing the concentration of the chemical additive in the fluid with a predetermined range of values;
wherein if the concentration of the chemical additive in the cleaning fluid is not within the predetermined range of values the fluid dispenser will prevent the fluid from flowing from the fluid container to the seat cleaning mechanism.

11. The self cleaning toilet seat of claim 10 further comprising:
a valve coupled between the fluid container and the seat cleaning mechanism;
wherein if the concentration of the chemical in the fluid is not within the predetermined range of values, the controller will close the valve.

12. The self cleaning toilet seat of claim 10 further comprising:
a pump coupled between the fluid container and the seat cleaning mechanism;
wherein if the concentration of the chemical in the fluid is not within the predetermined range of values, the controller will not actuate the pump.

13. The self cleaning toilet seat of claim 10 wherein the chemical additive is a salt and the sensor includes two electrodes and the sensor detects the electrical resistivity of the fluid.

14. The self cleaning toilet seat of claim 10 wherein the sensor includes an optical sensor that detects a light wavelength associated with the chemical additive.

15. A cleaning fluid dispenser comprising:
a fluid container for storing the cleaning fluid;
a chemical sensor coupled to the fluid container for detecting a concentration of a chemical additive in the fluid;
an optical sensor for detected a user's hand in the proximity of the cleaning fluid dispenser;
a controller coupled to the chemical sensor and the optical sensor for controlling a valve coupled to the fluid container;
wherein the controller opens the valve when the concentration of the chemical additive in the fluid with a predetermined range of values and the optical sensor detects the user's hand and the controller keeps the valve closed if the concentration of the chemical additive in the cleaning fluid is not within the predetermined range of values.

16. The cleaning fluid dispenser of claim 15 wherein the chemical additive is a salt and the sensor includes two electrodes and the sensor detects the electrical resistivity of the fluid.

17. The cleaning fluid dispenser of claim 15 wherein the sensor includes an optical sensor that detects a light wavelength associated with the chemical additive.

18. The cleaning fluid dispenser of claim 15 wherein the sensor includes an oxygen sensor that detects a dissolved oxygen level of the fluid.

19. The cleaning fluid dispenser of claim 15 wherein the sensor includes pH sensor that detects a pH level of the fluid.

20. The cleaning fluid dispenser of claim 15 wherein the chemical additive is a salt.
